(19) United States
(12) Patent Application Publication
(10) Pub. No.: US 2004/0188379 A1
(43) Pub. Date: Sep. 30, 2004

(54) Dielectric-in-dielectric damascene process for manufacturing planar waveguides

(75) Inventor: David G. Mikolas, Rowland Heights, CA (US)

Correspondence Address: STEVEN D WESEMAN, ASSOCIATE GENERAL COUNSEL, IP, CABOT MICROELECTRONICS CORPORATION, 870 NORTH COMMONS DRIVE, AURORA, IL, 60504, US

(73) Assignee: Cabot Microelectronics Corporation

(21) Appl. No.: 10/810,257

(22) Filed: Mar. 26, 2004

Related U.S. Application Data
(60) Provisional application No. 60/458,508, filed on Mar. 28, 2003.

(51) Int. Cl. B29D 11/00

(52) U.S. Cl. 216/24

(57) ABSTRACT

Photonic light circuits including one or more optical waveguides and one or more waveguide features and methods for manufacturing photonic light circuits including one or more optical waveguides.

### CROSS-REFERENCE TO RELATED APPLICATIONS

This patent application claims the benefit of U.S. Provisional Patent Application No. 60/458,508, filed on Mar. 28, 2003.

### FIELD OF THE INVENTION

This invention includes methods for manufacturing optical devices such as planar waveguides (PWG's) and photonic light circuits (PLC's) that include one or more planar waveguides wherein a dissimilar material is partially or totally inserted into the plane of a planar waveguide (structure) in such a way as to take advantage of a different optical, thermal, mechanical, or other properties of the dissimilar material in order to improve the function of the waveguide and/or to create totally new planar waveguide functionalities. The methods of this invention are useful for manufacturing PLC's as well as simpler PWG based devices such as semiconductor and waveguide lasers and amplifiers. Specifically, the invention is directed to methods for placing islands, inserts, and/or plugs of a material that is dissimilar to the waveguide material within a waveguide structure. These added features may simply improve the optical performance of planar waveguide structures, or they may form new passive or active optical devices.

### DESCRIPTION OF THE ART

PWG technology has applications in a number of fields, including but not limited to optical communications, remote sensing, and optical computing. The functions provided by PWG's are greatly limited by the restriction of signal confinement within a material that is optically homogeneous in the direction of propagation. By contrast, it is the multiple transitions between optically disparate materials in 3D optical systems, which makes them so powerful.

PWG's typically comprise a buffer or so-called undercladding layer deposited on a silicon substrate. This buffer layer may be silicon oxide, undoped or doped with one or more of boron, phosphorus and germania. Deposited on the buffer layer is a core layer, also typically of doped silicon oxide. There may be a stress compensating oxide layer deposited on the underside of the substrate to counteract any tendency of the oxides on top to cause thermal or other distortions. Optical signals are contained within the core layer by a lower refractive index arranged for the surrounding buffer and a cladding layer deposited on the core layer.

Conventional PWG's and PLC's can include features that facilitate optical communications. However, currently available PWG's are limited by the requirement that light remain in a single optical material on the substrate. As a result, current planar light circuit technology does not offer the possibility of a guided wave encountering multiple optical material transitions between different features, with the interfaces having arbitrary shapes in the lateral direction. Thus, there is a need for planar optical waveguides that include optical material transitions that form optical features.

### SUMMARY OF THE INVENTION

One aspect of this invention includes methods for manufacturing planar waveguide based devices including the steps of removing a portion of an exposed surface of a substrate to form a first cavity; depositing a layer of first optical material on the exposed substrate surface in an amount sufficient to fill the first cavity with the first optical material and to cover at least a portion of the exposed substrate surface; and removing at least a portion of the first optical material layer to form at least one planar waveguide.

In another aspect, this invention is a method for manufacturing a planar waveguide including at least one feature by the further steps including removing at least a portion of the first optical material located in the first cavity to form a second cavity; depositing a second optical material into the second cavity in an amount sufficient to fill the second cavity with the second optical material; and removing at least a portion of the second optical material from the substrate to form a feature. In both aspects of this invention described above, the first optical material and/or second optical material can be removed from the substrate by polishing and in particular by chemical mechanical planarization by applying a polishing composition to the exposed second optical material surface and thereafter removing at least a portion of the second optical material from the substrate by bringing a polishing substrate into contact with the second optical material and thereafter moving the polishing substrate in relation to the exposed surface of the fiber core.

Yet another aspect of this invention is PWG's and PLC's including a substrate having at least one optical waveguide wherein the optical waveguide comprises the combination of at least two optical materials associated with a substrate.

In still another aspect of this invention, the PWG and/or PLC include at least one optical waveguide feature that is preferably associated with one or more optical waveguides.

### DESCRIPTION OF THE FIGS.

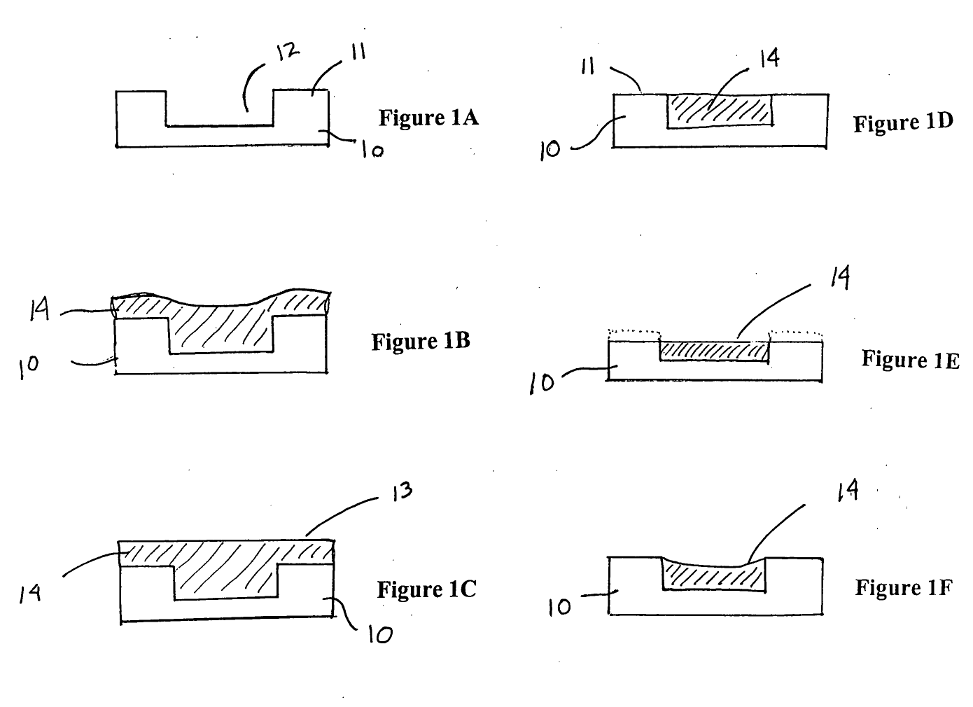

FIGS. 1A-1F are side cross-section views of a substrate during steps of a process of this invention for forming a planar waveguide on a substrate;

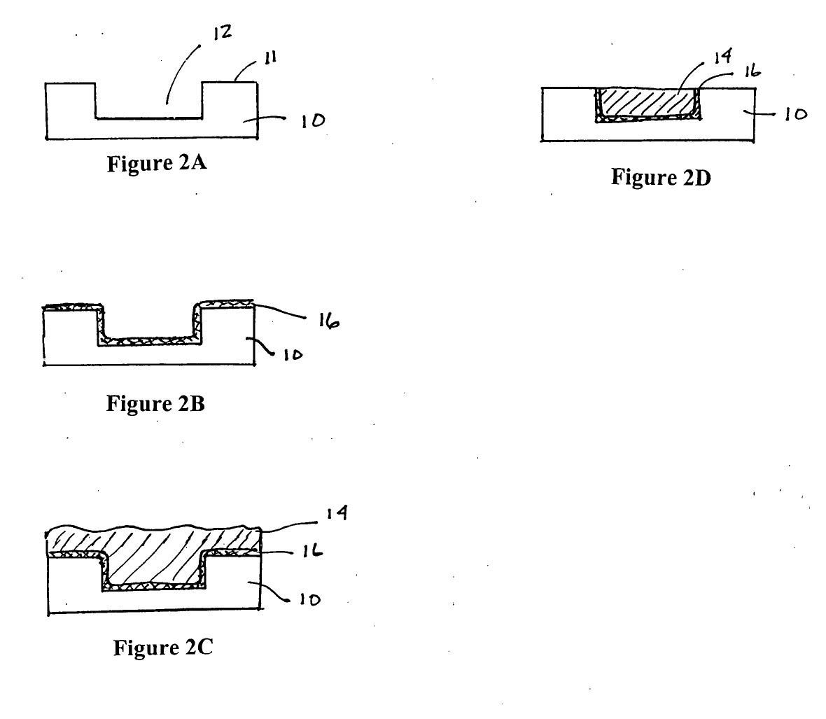

FIGS. 2A-2D are side views of a substrate during steps of a process of this invention for forming a planar waveguide on a substrate;

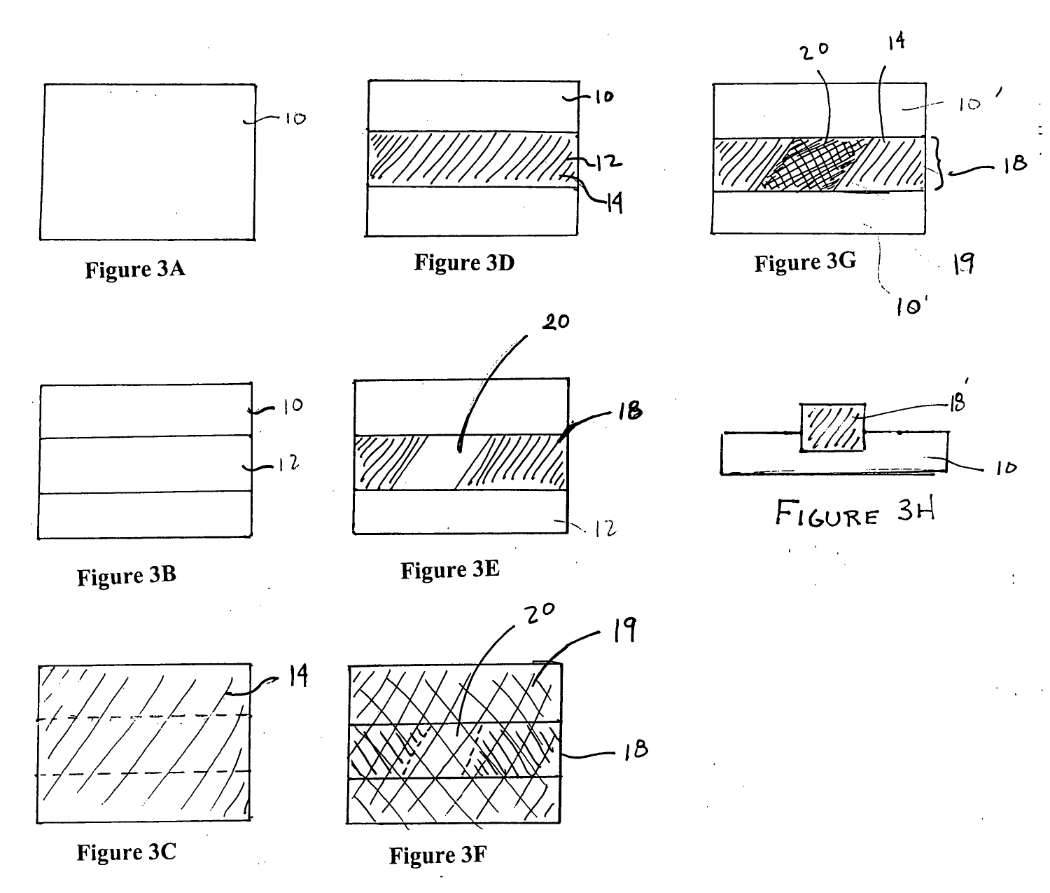

FIGS. 3A-3H are top views of a substrate during a process of this invention for forming planar waveguide include an optical feature;

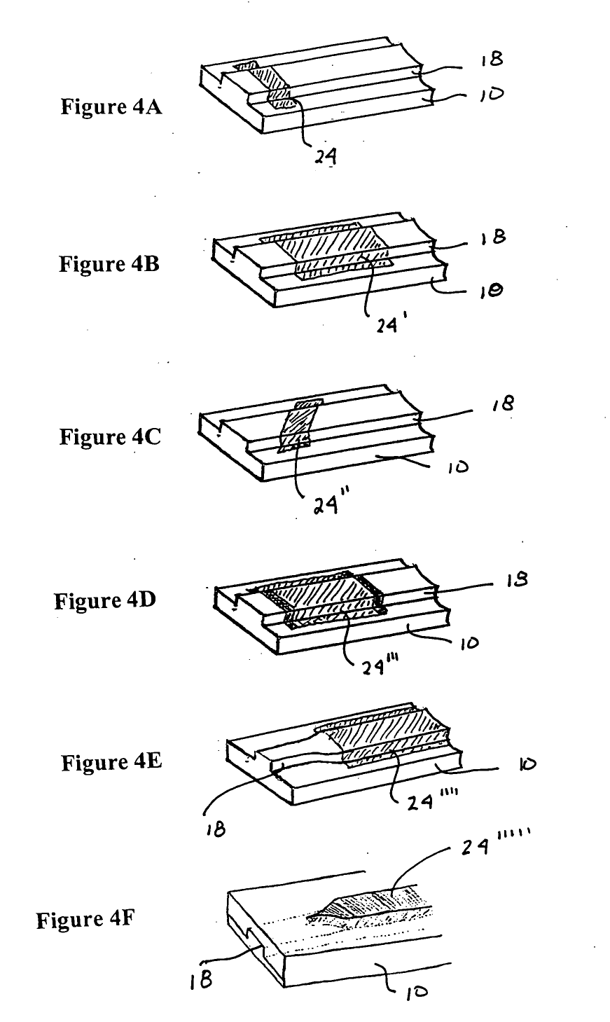

FIGS. 4A-4F are perspective views of portions of ridge waveguides including integral optical features that are formed by the methods of this invention.

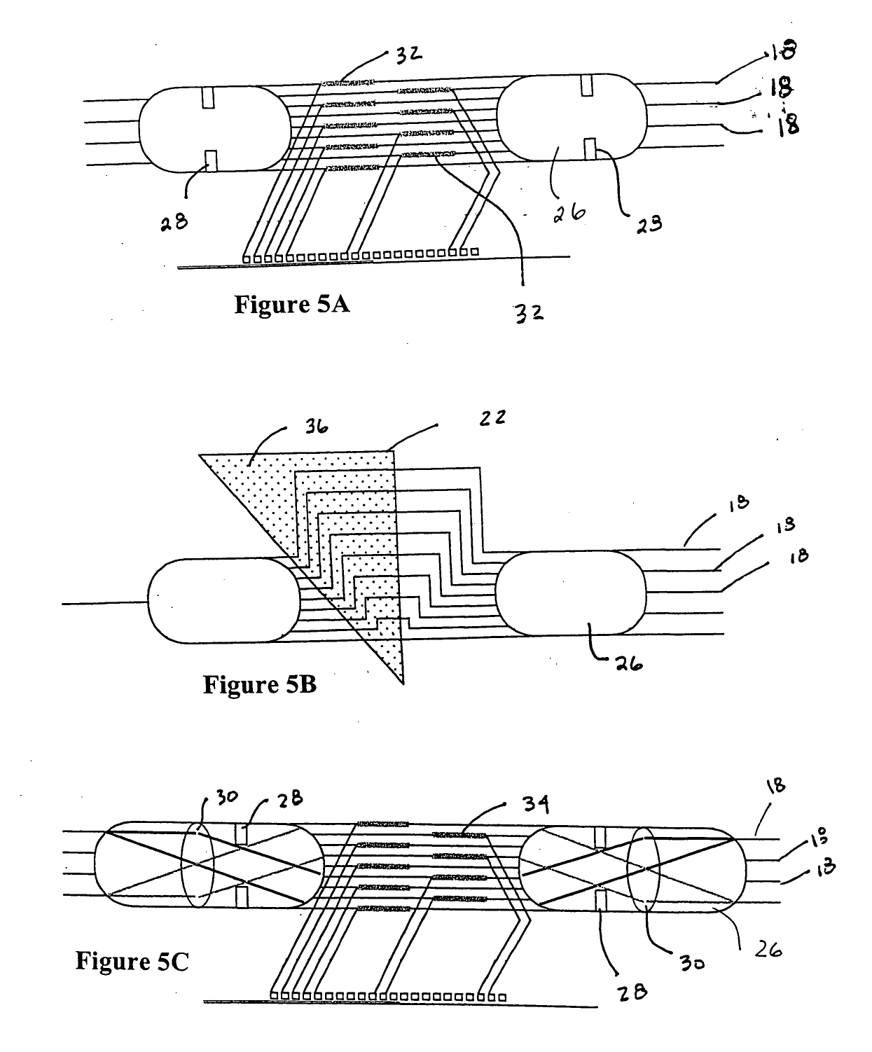

FIGS. 5A-5C are top views of examples of 2D PLC's that can be manufactured by the methods of this invention wherein the PLC's include a plurality of planar waveguides and one or more optical features;

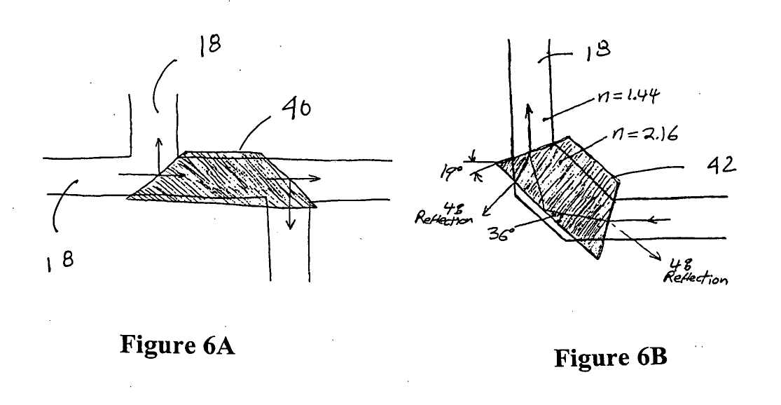

FIGS. 6A and 6B are overhead views of a waveguide bend optical feature that is capable of redirecting an optical signal; and

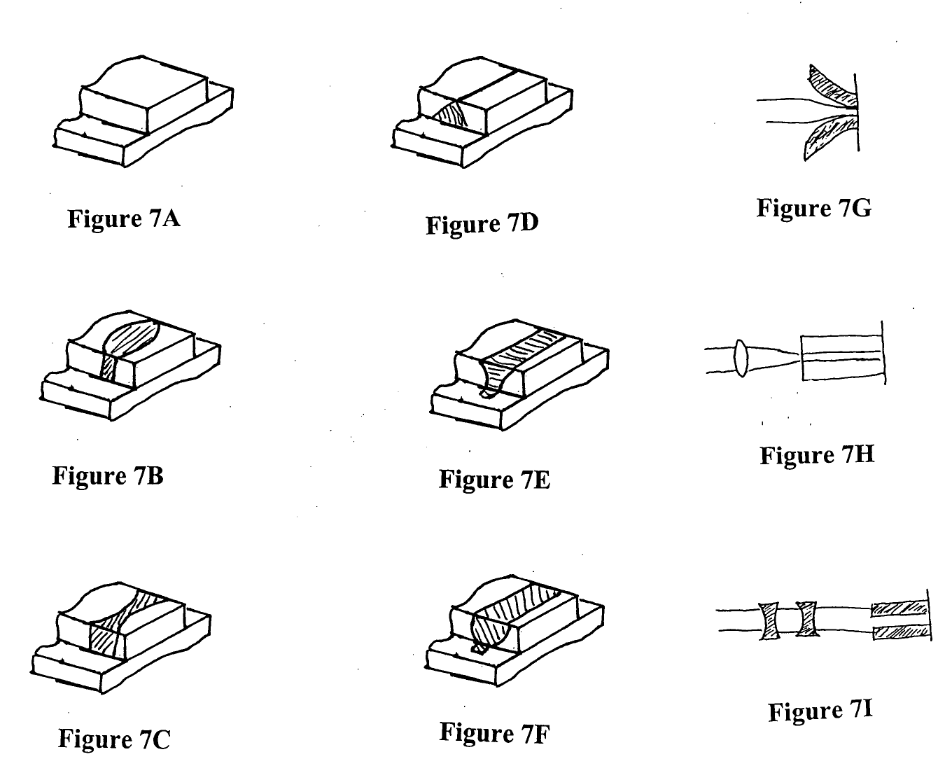

FIGS. 7A-7I are overhead views or cross-sections of planar waveguides that include at least one optical feature that form planar optical waveguides that include optical material transitions.

### DESCRIPTION OF THE CURRENT EMBODIMENT

This invention concerns methods for manufacturing planar optical waveguides (PWG's) and/or photonic light circuits (PLC's) that include one or more planar optical waveguides made from optical materials. The planar optical waveguides include at least a first optical material and may include one or more second optical materials having optical properties dissimilar to the first optical material properties. The first and optional second optical materials form optical features in one or more than one planar waveguides. The processes of this invention allow designers to create PWG's and PLC's having a variety of new passive and active optical devices including, but not limited to spatial filters, anamorphic beam shapers, aberration correctors, attenuation and beam jumpers, athermalization, Birefringence, polarizers, separators, thermal conductivity correctors, solubility correctors, phase shifters, beam steerers, optical power self-limiters, sharp angle turns, light generators, light amplifiers, lasers and so forth.

Several terms used in the specification and claims are defined below.

The term “essentially co-planar” refers to a substrate including at least two materials that are deposited or formed at different times but that are polished simultaneously to form a surface wherein the polished surfaces of both materials lie in the same plane or approximately the same plane. The definition allows for some deviation from co-planarity of the at least two materials that could be caused by factors such as over or under polishing of one material in comparison to another material.

The term “feature” refers to a material that has been located in or near the path of a planar optical waveguide and that alters in some manner the transmission of an optical signal moving through the planar waveguide. The term “feature” includes within its scope waveguides that have a first material portion and a second material portion such as, for example, a waveguide that is fabricated from an inorganic material where a portion of the inorganic material is replaced with an organic or polymeric material.

The term “host material” refers to a material that supports and/or provides a substrate for a waveguide. The “host material” or “substrate” may be an optically active material or an optically inert material.

This invention is directed generally to methods for manufacturing photonic light circuits PLC's including one or more planar optical waveguides (PWG's). The methods of this invention may be applied to PLC's including any 1-dimensional (1D) or 2-dimensional (2D) PWG's. For reference purposes, and optical fiber is a 1-dimensional waveguide. An optical fiber waveguide has a fiber center and a round “core” of higher index material that guides light from point A to point B by allowing light to propagate in one dimension while confining light in the other two dimensions. Such 1-dimensionsal waveguides can be generally referred to as a guiding structure. In this example, the optical fiber is a 1D waveguide in that light is confined in both Cartesian dimensions which are perpendicular to the direction of propagation.

The simplest planar waveguide is a slab or layer of higher index material (“sandwiched”) between two layers of lower index material. Here the guiding structure is the middle layer, sometimes still referred to as the core or core layer. The simple slab guiding structure is a 1D waveguide in that it only confines light in the direction perpendicular to the plane. The light may propagate in any direction within the plane.

If a ridge is patterned into the top of the guiding layer with sufficient width and depth, it will define a 2D waveguide—light propagating under the ridge will be confined laterally as well as vertically. Such ridge waveguide structures are shown in FIG. 4. An extreme limit to that example, where the guiding layer is completely removed except for the waveguide itself, is called a “channel” waveguide.

Waveguide structures can be fabricated by a variety of methods. For dielectric waveguides based on SiO₂, fabricated on Silicon wafers (Silica on Silicon), the first cladding layer (lower cladding) is followed by the core layer. A second cladding layer is then deposited (upper cladding). While air can serve as the upper cladding, changes in humidity and pressure and temperature will make small, but in some cases important changes in the effective index of the entire waveguide. Second, small amounts of water in the atmosphere can diffuse into the core layer, changing both index and attenuation of infrared signals. Finally, particulate matter falling on the exposed core surface will cause light to scatter out of the waveguide. Thus, an upper cladding is almost universally applied to form a PWG.

Many other methods of planar waveguide fabrication exist, even for manufacturing the same optical component. Examples of methods that can be used for fabricating 1D and 2D waveguides according to this invention include, but are not limited to quantum well interdiffusion methods, polymer UV or e-beam cross-linked waveguide fabrication techniques, Si:Ge UV bonds fabrication methods, chemical in-diffused or out-diffused method and combinations thereof.

In most methods for fabricating planar optical waveguides, a layer of waveguiding host material is formed on a substrate. The substrate will typically have a refractive index that is lower than the refractive index of the waveguiding host material. If the substrate does not have a refractive index that is lower than the refractive index of the waveguiding host material, a layer of a material, such as a layer of cladding or buffer material, with a suitable refractive index is formed between the substrate and the waveguiding host material. The planar waveguide is adapted to receive an optical signal and to receive power to amplify the optical signal. The waveguide is further adapted to output a signal that is an amplified input signal.

Examples of suitable substrates on which the host material may be formed include single crystalline quartz substrates, fused quartz substrates, aluminum oxide substrates, calcium fluoride substrates or silicon substrates. Since it is advantageous if the substrate's coefficient of thermal expansion matches that of the waveguiding host material, single crystalline quartz substrates and aluminum oxide substrates are advantageous in this regard. If the substrate has a higher refractive index than the waveguide, a film that forms an optical buffer or cladding layer as described above is formed on the substrate before the film of the host material is formed thereon. For example, if the substrate is a silicon substrate, the cladding or buffer material will typically have a refractive index lower than the refractive index of the waveguide. Silicon dioxide is an example of a suitable buffer or cladding layer material. The silicon dioxide layer is formed on the silicon substrate using conventional techniques.

Some methods of this invention for forming planar optical waveguides and planar light circuits including dissimilar optical materials are set forth in FIGS. 1A-1F, 2A-2D and FIGS. 3A-3H. In the method shown in FIGS. 1A-1F, a substrate 10, is etched to form a trench 12 as shown in FIG. 1A. Trench 12 will typically be formed by an etch process, such as reactive ion etching, deep reactive ion etching, wet etching, dry etching or by any other technique for forming trench 12 in substrate 10. Next, a first optical material 14 is deposited into trench 12 to a thickness sufficient to fill or to overfill trench 12 as shown in FIG. 1B. In FIG. 1C, at least a portion of first optical material is removed from the substrate by polishing to form a planar surface 13. It is preferred that the polishing step proceeds until top surface 11 of substrate 10 is exposed by the polishing step. Substrate over-polishing can result in either a reduction in the depth of first optical material filled trench 12 as shown in FIG. 1E, or it may result in dishing or doming depending on the polishing rates of the dielectric materials. Dishing or doming is generally undesirable and can be prevented or minimized by choosing substrate and first optical materials with similar polishing rates or by choosing a polishing composition that polishes the substrate and first optical material at similar rates. The product produced by the method shown in FIG. 1 includes a substrate 10 having a planar surface that includes first optical material 14 located in trench 12 where the first optical material 14 confined in trench 12 forms a planar optical waveguide. The surface of the substrate and first optical materials are essentially co-planar and can be etched or processed in subsequent steps to incorporate a variety of optical features.

FIGS. 2A-2D show an alternative process of this invention. In FIG. 2B, a film 16 is applied to trench 12 prior to applying the first optical material into trench 12. Film layer 16 will generally be at least a partially conformal film layer that is deposited, post-etch, to optically passivate the trench side wall roughnesses. It is preferred that the thickness of the film 16 on the trench side-walls is essentially the same as film 16 thickness on the trench bottom. Furthermore, the thickness of film 16 should be essentially equal to or exceed the scale of roughness of the trench side and bottom walls. In addition to a conformal film, a one quarter wave antireflective coating having a thickness of 50 to 400 nm and preferably about 175 to 225 nm or a stress compensating oxide layer can also be optionally deposited on the walls of trench 12 such that the film thickness on the trench side walls is essentially uniform. Alternatively, if the trench side wall and bottom side wall thickness is less than one quarter of the wavelength of the light passing through the first optical material, a single film can be used to provide both passivation and anti-reflection properties.

FIGS. 3A-3H are overhead views of a substrate undergoing a method according to this invention for applying an optical feature to a planar optical waveguide. According to the method shown in FIGS. 3A-3H, an optical device can be associate with a single planar optical waveguide or an optical feature can be applied simultaneously to a plurality of planar optical waveguides. The process steps shown in FIGS. 3A-3D are essentially the same steps shown in FIGS. 1A-1D and described above. In FIG. 3E, at least a portion of the first optical material comprising planar optical waveguide 18 is removed in order to form a exposed trench portion 20. First optical material 14 can be removed from planar optical waveguide 18 by the same etching methods described above for creating trench 12 in substrate 10. In FIG. 3F, a second optical material layer 19 applied to the substrate in order to fill second trench portion 20. Second optical material layer 19 may be applied conformaly or uniformly to the surface of substrate 10 in order to fill exposed trench portion 20. The term “conformaly applied” refers to first applying a mask or some protective layer to the portions of the substrate other than exposed trench portion 20 followed by applying second optical material 19 in a layer to the substrate. Finally, the second optical material layer portion that does not lie in and above trench portion 20 is removed from the substrate by etching or by some other means known in the art that leaves second optical material 19 located in second trench portion 20 essentially undisturbed. The excess second optical material 19 is removed by polishing techniques and preferably chemical mechanical polishing techniques until the substrate, first and second optical material layers are essentially coplanar.

Following substrate polishing, the substrate material surface, first optical material layer surface and second optical material layer surface should be essentially coplanar. In an optional step, the portions of substrate material that form the trenches can be partially or fully removed by etching or any other substrate removal method so that the optical material in trench 14 now lies above the surface of substrate 10. An end view of such a substrate including a ridge waveguide 18′ is shown in FIG. 3H.

Standard deposition and etching process techniques can be used to manufacture the products of this invention. For example, etching techniques with or without the use of a photomask can be used to form trenches in the substrate or first optical material layer. Materials can be deposited in the trenches with or without the use of photomasks as well. Further, standard integrated circuit deposition process such as plasma deposition, vapor deposition, chemical vapor deposition, etc. can be used to deposit optical materials into the trenches and onto the substrate surfaces.

The methods of this invention are useful for manufacturing a variety of planar optical waveguides (channel waveguides or ridge waveguides) that include optical features made of optical materials that are dissimilar to the optical materials used to fabricate the waveguides. Examples of ridge waveguides including features made of dissimilar optical materials are depicted in FIGS. 4A-4F. FIGS. 4A-4F show a substrate 10 including planar optical waveguide 18 and an optical feature 24. In FIG. 4A feature 24 is an in-line attenuator of arbitrary value. In FIG. 4B feature 24′ is a large value attenuator or beam dump. In FIG. 4C, feature 24″ is an angled facet that is capable of sending instructions into non-guided mode. In FIG. 4D, feature 24′″ is an attenuator or beam dump with a conformal antireflection pre-coat. In FIG. 4E, feature 24′″ is an expanding waveguide in which any back-reflection from the attenuator material interface will have a convex phase profile. Such devices can be tuned so that the wrong phase profile causes zero/coupling into the waveguide. Finally, FIG. 4F, feature 24′″″ is a high-index, heavily absorbing material applied on top of a ridge or slightly inset so that it is weakly coupled to the guided mode. The material is dovetailed to present reflection. The same features applied to ridge waveguides in FIGS. 4A-4E can be applied to any 1D and 2D waveguide.

The substrate, first, and second optical materials, and any subsequent optical materials used in the present invention may be any optical materials that are known in the art to be useful for manufacturing photonic light circuits, planar optical waveguides, and optical features associated with both. The term “optical materials” refers to organic materials including polymers, inorganic materials, and combinations thereof that have a real index of refraction and do not absorb light in appreciable amounts. Examples of suitable depositable optical materials include, but are not limited to single crystalline quartz substrates, fused quartz, aluminum oxide, calcium fluoride, silicon polymers, polymers, materials including gasses and so forth. Since it is advantageous if the substrate's coefficient of thermal expansion matches that of the host material, single crystalline quartz substrates and aluminum oxide substrates are advantageous in this regard. If the substrate has a higher refractive index than the optical waveguide material, a film that forms an optical buffer layer or anti-reflection coating is preferably formed on the substrate before the trench is filled with second dielectric material. For example, if the substrate is a silicon substrate, the antireflective coating is a material that has a refractive index lower than the refractive index of the planar waveguide. Silicon dioxide is an example of a suitable antireflective material. The silicon dioxide layer is formed on the silicon substrate using conventional techniques.

As indicated above, waveguides 18 may be fabricated partially or entirely from a polymer material or from a material including a polymer such as a silicon/polymer material. One example of a useful polymer is a deuterated and halogenated polysiloxane as described in U.S. Pat. No. 5,672,672, the specification of which is incorporated herein by reference. Other useful polymer materials include, but are not limited to polysiloxanes, acrylates, polyimides, polycarbonates, etc., with optional deuteration or halogenation to reduce optical losses in the infrared, adjust the index of refraction, and adjust adhesion to other layers.

Waveguides 18 may also be fabricated from spun-on polymer layers chemically selected with a raised index for the core layer, and patterned by reverse ion etching (RIE). Alternative substrates include InP, GaAs, glass, silica, lithium niobate, lithium tantalate, etc. Alternative waveguide materials include oxides such as Ta₂O₅, Nb₂O₅, TiO₂, HfO₂, and SiO₂, semiconductor materials such as silicon, GaAs, InP, polymers, and doped or mixed versions of all of the above materials with various dopants including phosphorus, hydrogen, titanium, boron, nitrogen, and others. Alternative fabrication methods include indiffusion, sputtering, evaporation, wet and dry etching, laser ablation, bleaching, and others. Many different waveguide structures are also available including planar, rectangular, elliptical, ridge, buried ridge, inverted ridge, diffused, air clad, hollow, coated, cladding stripped, 3-layer, 4-layer, 5-layer, etc. Combinations of the above materials, methods, and structures may be used as long as the process flows are compatible (i.e. do not result in decomposition, delamination, or unacceptable chemical change or physical modification of the materials of the semi-processed article), the optical losses are reasonably low (i.e. below 10 dB/cm for very short chips and below about 1 dB/cm for longer waveguides), and the transverse index of refraction profile of the finished structure has a locally higher index of refraction compared to adjacent materials in at least one dimension, creating at least a planar waveguide that guides light in one dimension or a channel waveguide that guides light in two dimensions.

A conformal antireflective material may be deposited as a single material or simultaneously from separate sources using conventional deposition apparatus such as evaporation ovens, electron beam evaporators, and the like. In one embodiment, a trivalent conformal layer is formed using LaF₃, YF₃ or LuF₃ as source materials. Sources and techniques for depositing the conformal layers and dielectric materials specified above onto substrates are well known to those skilled in the art. Such techniques include, but are not limited to plasma deposition, furnace deposition, vapor deposition and so forth. Regardless of the deposition method chosen, it is important that hydrogen is not incorporated into the deposited material layer. It may be advantageous if the temperature of the substrate during the formation of the doped, host material layer is about 300° C., to about 600° C.

The thickness of the waveguide material layer so formed is a matter of design choice. Film thicknesses of from about 4 μm to about 12 μm or more are contemplated. Film thicknesses of from 6-10 μm are more typical.

FIG. 5A depicts a PLC that can be manufactured by the method of this invention. The PLC shown in FIG. 5A includes a plurality of waveguides 18 which are associated with grating 26 that includes an aperture 28. The second optical material is applied over a plurality of planar optical waveguide 18 to form an optical feature 32. The optical feature 32 shown in FIG. 5A is an active temperature compensation device. Thus, according to this invention, optical feature 32 may be applied to a single planar optical waveguide 18 or simultaneously to a plurality of planar optical waveguides 18.

FIG. 5B depicts a waveguide grating router including gratings 26 and a plurality of waveguides 18. The waveguide grating router further includes a feature 36 comprising a chevron of second optical material with a coefficient of expansion that is the opposite of the coefficient expansion of the planar optical waveguide material. Feature 36 is a passive temperature compensation device in which the length of each planar optical waveguide 18 inside feature 36 is equivalent to the length of planar optical waveguide that lies outside of feature 36. Feature 36 passively compensates for changes in temperature in the waveguiding router so that optical signals passing through planar optical waveguide 18 arrive at grating 26 essentially simultaneously. FIG. 5B thus is a good example of a single feature 36 that is associated with a plurality of waveguides 18.

FIG. 5C is a waveguiding router that includes a plurality of planar optical waveguides 18, gratings 26 and apertures 28 in gratings 26. Gratings 26 further include a lens 30. A feature 34 is associated with each planar optical waveguide at a location between gratings 26. Feature 34 is an attenuator, or a blocker or a deflector that can be used to selectively block optical signals passing through planar optical waveguides 18.

FIGS. 6A and 6B depict feature 40 and 42 associated with a planar optical waveguide 18. Feature 40 of FIG. 6B, is a polarization beam sampler. For a given ratio of refraction of the two optical materials, the p-polarization of the incident light is completely transmitted at a certain incidence angle that, for most dielectric systems, will be between 30° and 60°. At this angle, the reflected light is purely s-polarization. Measuring the ratio of this reflective s-component to the transmitted waves produces a real-time measurement of polarization dependent loss and provides feedback for real-time optical signal correction. Feature 42 shown in FIG. 6B is a space saving beam bending feature. Photonic light circuits made in silicon oxide have weak confinements because the core and plating regions have similar indexes of refraction. This means that the bending radius of a SiO₂-based waveguide is 3-5 millimeters. Higher index materials allow for a smaller bending radius. Feature 42 in FIG. 6B is similar to prisms inside binoculars. It uses total internal reflection to direct light around a corner. Such a total internal reflection feature allows for the use of a low index material with low reflective losses. It further allows for finite diversions of an optical beam and decreases the length of the evanescent wave into the waveguide material behind the reflecting phase.

FIGS. 7A-7I are non-limiting examples of additional features that can be associated with optical waveguides. FIG. 7A is a standard ridge waveguide at the edge of a platonic light circuit guide. The waveguide of FIG. 7B includes a lens shaped feature that is etched down and filled with a high index material (for focusing a convex wave front) or low index material or air (for diverging a concave wave front). The waveguide of FIG. 7C includes a diverging lens feature. FIG. 7D includes a horizontally deflecting prism. The waveguide of FIG. 7E includes a vertically deflecting prism. The waveguide of FIG. 7F includes a vertically focusing lens. The waveguide of FIG. 7G includes a feature that gradually changes the width of the weight guide and its mode for eventual coupling to a narrower mode device such as an antigrated InP, GaAs or silicon waveguide. The shaded area as shown is a low-index material. As the low-index material gets closer to the guided region, the beam confinement gets stronger. This allows the width of the guiding region in the mode to shrink. As long as the transition is slow, reflections and losses can be minimized. The waveguide of FIG. 7H includes a feature that has the same function as the feature shown in FIG. 7G—to narrow the guided mode. In FIG. 7H, the feature is an inserted lens that forms a conversion wave front that is weakly guided by the shrinking waveguide. Once it has reached the appropriate size, the waveguide structure is increased and index in a smaller size remains stable. FIG. 71 depicts a waveguide that includes a pair of low index negative lens features that focus like positive lenses. Once the waveguide reaches a smaller diameter, the low index inserts maintain optical signal confinement.

Other features that can be applied to waveguides by the methods of this invention include waveguide lasers and waveguide amplifiers. Waveguides including lasers and amplifiers are disclosed in U.S. Pat. Nos. 5,640,411, 5,966,481, 6,192,061, 6,304,711 and 6,456,637, the specifications of each of which are incorporated herein by reference.

The processes of this invention allow for the application of a wide variety of planar optical waveguide features into a platonic light circuit. It is anticipated that the methods of this invention will provide circuit designers with a new tool for designing and miniaturizing platonic light circuits.

An important aspect of the processes of this invention is the use of polishing techniques and preferably chemical mechanical planarization (CMP) techniques to controllably remove material from the surface of substrate 10 and to impart co-planar surface to the substrate and resulting waveguide and/or PLC. Any procedures that are known to those of skill in the art for controllably removing materials from a surface of a small substrate may be utilized in this invention. It is preferred that polishing processes are used. The polishing process can be hand polishing or mechanical polishing processes. The polishing processes can utilize a polishing substrate such as a cloth or a polishing pad alone or in conjunction with a liquid or aqueous polishing composition. It is most preferred that chemical mechanical polishing techniques are used to remove at least one material or material layer from the substrate during the process of this invention.

In a typical CMP process, the substrate surface that is being polished is placed into contact with a rotating polishing pad. A carrier applies pressure against the backside of the substrate. During the polishing process, the pad and table are rotated while a downward force is maintained against the substrate back. A polishing composition is applied to the interface between the polishing pad and the substrate surface being polished. The polishing composition can be applied to the interface by applying the polishing composition to the polishing pad surface, to the substrate surface being polished or both. The polishing composition can be applied to the interface either intermittently or continuously and the application of the polishing composition can begin prior to or after the polishing pad is brought into contact with the substrate surface being polished. Finally, the term “applying a polishing composition” as it used in the specification and claims is not time limited and refers to the application of a polishing composition either before, during, or after a polishing substrate is moved into contact with the surface being polished.

The polishing composition is formulated to include chemicals that react with and soften the surface of the material being polished. The polishing process further requires an abrasive material to assist in removing a portion of the substrate surface that has been softened by a reaction between the polishing composition and the substrate surface material. The abrasive may be incorporated into a polishing pad such as the polishing pads disclosed in U.S. Pat. No. 6,121,143 which is incorporated herein by reference; it may be incorporated into the polishing composition, or both. Ingredients in the polishing composition or slurry initiate the polishing process by chemically reacting with the material on the surface of the substrate that is being polished. The polishing process is facilitated by the movement of the pad relative to the substrate as the chemically reactive polishing composition or slurry is provided to the substrate/pad interface. Polishing is continued in this manner until the desired film or amount of film on the substrate surface is removed.

The movement of the polishing pad in relationship to the substrate can vary depending upon the desired polishing end results. Often, the polishing pad substrate is rotated while the substrate being polished remains stationary. Alternatively, the polishing pad and the substrate being polished can both move with respect to one another. The polishing substrates and in particular the polishing pads of this invention can be moved in a linear manner, they can move in a orbital or a rotational manner or they can move in a combination of the directions.

The choice of polishing composition or slurry is an important factor in the CMP step. Depending on the choice of ingredients such as oxidizing agents, film forming agents, acids, bases, surfactants, complexing agents, abrasives, and other useful additives, the polishing slurry can be tailored to provide effective polishing of the substrate layer(s) at desired polishing rates while minimizing surface imperfections, defects and corrosion and erosion. Furthermore, the polishing composition may be selected to provide controlled polishing selectivities to other thin-film materials used in substrate manufacturing. In the case of PLC surface polishing, it is preferred that the polishing compositions are engineered such that the polishing composition polishes the substrate material and the first, second and subsequent optical materials at essentially the same rate to prevent our polishing or underpolishing of material layers.

Examples of some useful polishing compositions and slurries are disclosed, in U.S. Pat. Nos. 6,068,787, 6,063,306, 6,033,596, 6,039,891, 6,015,506, 5,954,997, 5,993,686, 5,783,489, 5,244,523, 5,209,816, 5,340,370, 4,789,648, 5,391,258, 5,476,606, 5,527,423, 5,354,490, 5,157,876, 5,137,544, 4,956,313, the specifications of each of which are incorporated herein by reference.

It is important that the methods of this invention produce a planar waveguide having a smooth surface. The term “smooth surface” means a polished surface in the core region having a RMS roughness of less than 100 Å, preferably less than 10 Å, and most preferably less than 5 Å.

The methods of this invention can be used to manufacture of a variety of PLCs including novel integral optical features. One example of a PLC with a novel optical feature is shown in FIG. 5A which depicts a typical waveguide grating router. A waveguide grating router is a high-resolution device that can be highly sensitive to small temperature changes. Typically temperature is controlled by PLC into an oven and keeping the PLC at a temperature potentially higher than ambient temperature. In FIG. 5A, the temperature is controlled with a passive temperature compensation device 36. Passive temperature compensation device 36 is selected from a material that it is affected by a temperature (dn/dT) in a manner that is opposition that of the dn/dT of the planar optical waveguide material. In FIG. 5A, a chevron of second optical material 22 is inserted into the waveguide system so that each waveguide spends the same fraction of its links in passive temperature composition device 36. In this way, the planar optical waveguides making up the waveguide grating router are passively temperature compensated and the waveguide grating routers can be deployed anywhere without a need for cooling, heating or temperature regulation.

While the present invention has been described by means of specific embodiments, it will be understood that modifications may be made without departing from the spirit of the invention. The scope of the invention is not to be considered as limited by the description of the invention set forth in the specification and examples, but rather as defined by the following claims.

1. A method for manufacturing a planar light circuit comprising the steps of:
(a) removing a portion of an exposed surface of a substrate to form a first cavity;
(b) depositing a layer of first optical material on the exposed substrate surface in an amount sufficient to fill the first cavity with the first optical material and to cover at least a portion of the exposed substrate surface; and
(c) removing at least a portion of the first optical material layer to form at least one planar waveguide.

2. The method of claim 1 wherein at least a portion of the first optical material layer is removed by polishing.

3. The method of claim 1 wherein removing step (c) is accomplished by chemical mechanical planarization.

4. The method of claim 3 wherein the chemical mechanical planarization comprises the further steps of:
(i) applying a polishing composition to the first optical material layer; and
(ii) removing at least a portion of the first optical material layer from the substrate by bringing a polishing substrate into contact with the first optical material layer and thereafter moving the polishing substrate in relation to the exposed surface of the fiber core.

5. The method of claim 1 wherein the first optical material layer is removed in step (c) until the substrate surface and the first optical material layer surface are essentially co-planar.

6. The method of claim 1 wherein at least one film layer is deposited in the first cavity before the first optical material is deposited in the first cavity.

7. The method of claim 6 wherein the film layer is selected from the group of layers consisting of a stress compensating oxide layer, an antireflective material layer, a conformal film layer and layer combinations thereof.

8. The method of claim 1 wherein a feature is added to the planar light circuit by the further steps comprising:
(i) removing at least a portion of the first optical material located in the first cavity to form a second cavity;
(ii) depositing a second optical material into the second cavity in an amount sufficient to fill the second cavity with the second optical material; and
(iii) removing at least a portion of the second optical material from the substrate to form a planar light circuit feature.

9. The method of claim 8 wherein the second optical material has a refractive index that is different from the refractive index of the first optical material.

10. The method of claim 8 wherein the feature is associated with one optical waveguide.

11. The method of claim 8 wherein the feature is associated with at least two optical waveguides.

12. The method of claim 8 wherein the feature is selected from the group consisting of spatial filters, anamorphic beam shapers, aberration correctors, attenuation and beam jumpers, athermalization, Birefringence, polarizers, separators, thermal conductivity correctors, solubility correctors, phase shifters, beam steerers, optical power self-limiters, sharp angle turns, light generators, light amplifiers, lasers and combinations thereof.

13. The method of claim 8 wherein the second optical material is removed from the substrate by chemical mechanical planarization.

14. The method of claim 13 wherein the chemical mechanical planarization comprises the further steps of:
(i) applying a polishing composition to the exposed second optical material surface; and
(ii) removing at least a portion of the second optical material from the substrate by bringing a polishing substrate into contact with the second optical material and thereafter moving the polishing substrate in relation to the exposed surface of the fiber core.

15. The method of claim 14 wherein the second optical material is removed until the first optical material and the second optical material are essentially co-planar.

16. The method of claim 4 or 14 wherein the polishing substrate is a polishing pad.

17. The method of claim 16 wherein the polishing pad is a fixed abrasive polishing pad.

18. The method of claim 4 or 14 wherein the polishing composition includes abrasive particles.

19. The method of claim 14 wherein the second optical material is removed until the substrate surface, the first optical material layer surface and the second optical material layer surface are essentially co-planar.

20. The method of claim 1 wherein the first optical material is selected from an organic material, and inorganic material, or a combination thereof.

21. The method of claim 20 wherein the first optical material includes a polymer.

22. A planar light circuit including a substrate having at least one optical waveguide wherein the optical waveguide comprises two or more optical materials located in a cavity in the substrate.

23. The planar light circuit of claim 22 wherein the substrate has a surface and the optical materials each have a surface and wherein the substrate surface and the optical material surfaces are essentially co-planar.

24. The planar light circuit of claim 23 having an RMS surface roughness less than about 100 Å

25. The planar light circuit of claim 20 wherein at least one optical material forms an optical waveguide feature.

26. The planar light circuit of claim 27 wherein the optical waveguide feature is made from a second optical material having a diffractive index that is different from the diffractive index of the optical waveguide material.

27. The planar light circuit of claim 26 wherein the optical waveguide feature has a polished surface.

28. The planar light circuit of claim 27 wherein the optical waveguide includes a polished surface that is essentially co-planar with the polished surface of the optical waveguide feature.

29. The planar light circuit of claim 28 wherein the polished surface has an RMS roughness less than about 10 Å.

30. The planar light circuit of claim 23 wherein the optical waveguide feature is associated with one optical waveguide.

31. The planar light circuit of claim 23 wherein the optical waveguide feature is associated with at least two optical waveguides.

32. The planar light circuit of claim 23 wherein the optical waveguide feature is selected from the group consisting of spatial filters, anamorphic beam shapers, aberration correctors, attenuation and beam jumpers, athermalization, Birefringence, polarizers, separators, thermal conductivity correctors, solubility correctors, phase shifters, beam steerers, optical power self-limiters, sharp angle turns, light generators, waveguide amplifiers, waveguide lasers, and combinations thereof.

33. The planar light circuit of claim 32 wherein the optical feature is a waveguide amplifier.

34. The planar light circuit of claim 32 wherein the optical feature is a waveguide laser.
